(19) United States
(12) Patent Application Publication
(10) Pub. No.: US 2016/0345137 A1
(43) Pub. Date: Nov. 24, 2016

(54) INDOOR NAVIGATION SYSTEMS AND METHODS

(71) Applicant: Toshiba America Business Solutions, Inc., Irvine, CA (US)

(72) Inventor: Adiel Ruiz, Irvine, CA (US)

(73) Assignee: TOSHIBA AMERICA BUSINESS SOLUTIONS, INC., Irvine, CA (US)

(21) Appl. No.: 14/719,259

(22) Filed: May 21, 2015

(51) Int. Cl. H04W 4/04; H04W 4/02

(52) U.S. Cl. CPC H04W 4/04; H04W 4/027

(57) ABSTRACT

According to one embodiment, a system is configured to provide navigation information to an optical head-mounted display (OHMD) of a user. The system includes a server configured to determine a current location of the user in a building, and to receive a request from a user, where the request relates to a query to find a defined destination in the building. The server determines a destination location within the building corresponding to a location of the defined destination, and generates directions to guide the user to the destination location from the current location. The server generates an augmented display for the OHMD of the user, relating to the generated directions, the destination location or both.

### FIELD

Embodiments described herein relate generally to systems and methods for providing locational directions to a user and, in particular embodiments, for providing locational directions to a user in an indoor environment.

### BACKGROUND

In certain large buildings or building complexes, it may be difficult for a person to find a desired destination (e.g., a particular room, a particular location within a room or other defined area, a particular device or object within a room or other defined area, or the like). In some building or building complexes, a map or other guide is posted or displayed, to provide locational information. Even with such a map or guide display, it may take a considerable amount of time for a person to find a desired destination location, especially if the person is not familiar with the layout of the building. In addition, the maps or guides provided at different buildings or building complexes (or even within the same building or complex) can differ from each other in design, layout or other aspects of information presentation, which can add further complications to the person's ability to find a desired destination.

In some contexts, a person in a building or a building complex may wish to find a particular device or other object located somewhere in the building or complex. For example, a person may wish to find each (or the nearest) printer or copier device in the building complex, or may wish to find each (or the nearest) printer or copier device that the particular user is authorized to use. However, the maps or guides posted in a building or building complex might not show the specific object that the person is seeking, or may add further complexity by showing many other objects that are not being sought.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an indoor navigation system, according to an exemplary embodiment.

FIG. 2 is an example floor plan of a building environment in which an indoor navigation system is implementable, according to an exemplary embodiment.

FIG. 3 is an example head-up display (HUD) that may be generated for a user by an indoor navigation system, according to an exemplary embodiment.

FIG. 4 is a detailed block diagram of a server of an indoor navigation system, configured to execute various functionalities of the indoor navigation system, according to an exemplary embodiment.

FIG. 5 is a flow chart of a process for providing navigation assistance to a user in a building environment, according to an exemplary embodiment.

### DETAILED DESCRIPTION

According to one embodiment, a system for providing navigation information is disclosed. The system is configured to provide navigation information to an optical head-mounted display (OHMD) of a user. The system includes a server configured to determine a current location of the user in a building environment. The server further receives a request from a user, the request relating to a query to find a defined destination in the building environment. The server determines a destination location within the building environment corresponding to a location of the defined destination. The server generates directions to guide the user to the destination location from the current location. The server further generates an augmented display for the OHMD of the user, the augmented display relating to the generated directions, the destination location or both the generated directions and the destination location.

In one embodiment, the system (described as an indoor navigation system henceforth) may be used to locate a device, such as, but not limited to a printer device or a copier device, in the building environment. For example, the user may employ the indoor navigation system to locate the nearest or most accessible printer or copier device for use. As another example, the user may employ the indoor navigation system to find a specific printer or copier device, such as, but not limited to, a specific device that has one or more desired functions, or is configured or authorized for the user to use.

The OHMD may be, for example, but not limited to a Google Glass device or any other suitable, portable device with a head-up display (HUD). The OHMD is configured to display images and other information to a user wearing the device, for example, to provide the user with an augmented view of reality. In particular embodiments, navigation information is presented to the user through the OHMD. The term OHMD is used herein to describe a wearable device. In yet other embodiments, other suitable, portable communication devices with display screens (with or without head-up display capabilities) are employed in place of an OHMD. However, particular embodiments are described herein as employing an OHMD configured to be worn on the head of a user to provide a head-up display that the user can view in conjunction with (to augment) the user's real world view of the immediate environment.

In one embodiment, the indoor navigation system is configured to receive location information from an OHMD and/or another mobile device carried by the user. For example, the OHMD includes a camera configured to capture images of the surrounding environment. The images may be communicated to and analyzed by a server or a mobile device carried by the user (or by processing electronics in the OHMD, itself), for example, to identify the location of the user from information provided in the images. In one embodiment, the building environment may include one or more tags, signs or other location identifiers that can be read by the OHMD. For example, a plurality of barcodes, QR codes, other optically readable codes, RFID tags, magnetically readable tags or other electronically readable tags, may be arranged at a corresponding plurality of predefined locations throughout the building environment.

The OHMD may read one or more tags in a given location, and communicate information read from the tags to processing electronics (for example, processing electronics in a mobile device carried by the user, in a remote server, or in the OHMD, itself). The processing electronics may be configured to determine the location of the user based on the information read from the tags. Further, the processing electronics (e.g., in the mobile device, remote server or OHMD, itself) may use other information from devices included in or associated with the OHMD or the mobile device to locate the user. For example, a gyroscope in or associated with the OHMD or the mobile device may be used to determine the orientation and direction of the user. As another example, an accelerometer in or associated the OHMD or the mobile device may be used to determine the motion of the user.

Further, wireless communication devices in the building environment may be used to locate the user. For example, one or more WiFi devices that provide WiFi hotspots in the building environment may be configured to detect the mobile device of the user, and may be able to determine the location of the user in the building environment (relative to a known location of the WiFi hotspot) based on a strength of signal from the OHMD or mobile device, and based on which WiFi hotspot device detected the mobile device. In further embodiments, the OHMD or the mobile device of the user may be configured to detect WiFi hotspots in the building environment and determine the location of the user in the building environment (relative to a known location of the WiFi hotspot) based on the strength of the signal from the WiFi hotspot device and which WiFi hotspot device provided the signal.

In one embodiment, the indoor navigation system is configured to project navigation information in a head-up display of the OHMD. For example, if the user desires directions to a printer (or other pre-defined destination device), the indoor navigation system may be configured to display a printer icon (or other destination device icon) on the OHMD of the user. The icon may be a picture, drawing, photograph, symbol, text or other indicator that represents the printer (or other destination device). In particular embodiments, the icon is a drawing or photograph that appears similar or identical to the actual printer or other destination device. The icon may be displayed in a position in the head-up display that corresponds to or represents the actual, physical location of the printer in the building environment, as if in view through any walls or obstacles located between the user and the printer. This allows for the user to see the general direction of the physical location of the destination, as an icon of a destination device (e.g., the printer) on the head-up display, while also seeing the real world view of a building interior through or around the head-up display. The indoor navigation system may further be configured to display supplemental information on the head-up display of the OHMD, such as the distance to the printer, turn-by-turn instructions, or other information.

In one embodiment, the indoor navigation system receives a request from a user to find a particular device, object, or location. For example, the indoor navigation system may receive a request from a user for the nearest printer. In response, the indoor navigation system may locate the nearest printer. In one embodiment, the indoor navigation system retrieves one or more pre-stored printer locations from a database or other storage. In another embodiment, the indoor navigation system transmits a request over a network for printers, receives a response message from one or more printers connected on the network, and determines the nearest available printer based in part on the response messages.

Various embodiments are described in which the user requests to find a particular device or destination location within the building environment, where the device is a printer or copier device and the destination location is the physical location in the building environment of that printer or copier. The use of the indoor navigation system to find a printer or copier is provided by way of example only, and is not limiting, such that it should be understood that the systems and methods herein may be used to locate other devices, objects or locations within a building environment. For example, the indoor navigation system may be used to locate other types of electronic devices, machines, furniture items, access doors, fire extinguishers or other emergency equipment, medical supplies or equipment, or the like, and to provide navigation assistance to assist the user in finding the desired device, object or location. As another example, the indoor navigation system may be used to locate a particular room, area, or other landmark within the building environment, and to provide navigation assistance to that room, area or landmark. As another example, the indoor navigation system may be used to provide an evacuation route to a user during an emergency (i.e., providing an evacuation route to the nearest fire exit during an emergency). As another example, the indoor navigation system may be used to locate personnel (one or more predefined people) in a building area, and to guide a user to the personnel.

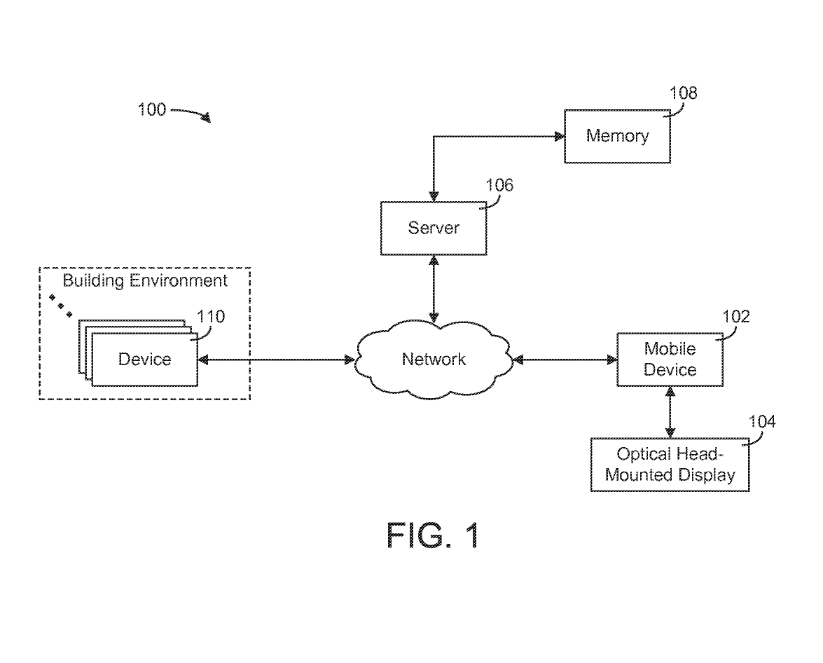

Referring to FIG. 1, a block diagram of indoor navigation system 100, according to an exemplary embodiment, is shown. System 100 generally includes a mobile device 102 and an OHMD 104 of a user. The mobile device 102 and/or the OHMD 104 is configured to operate as described herein, to provide navigation information to the user. In particular embodiments, one or both of the mobile device 102 and the OHMD 104 are connected for communication over a communication network 101. In the embodiment of FIG. 1, the OHMD 104 is connected for communication with the mobile device 102 via a local communication connection link 103, while the mobile device 102 is connected for communication over the communication network 101 via a network connection 105. In other embodiments, the OHMD 104 is connected to the network 101, through a network connection (similar to network connection 105), without the mobile device 102 interposed between the OHMD 104 and the network 101.

The OHMD 104 may be any suitable, portable device with a head-up display (HUD) as described above, for example, but not limited to a Google Glass device. While Google Glass is described as an example OHMD, it should be understood that the systems and methods herein may include (as the OHMD 104) any other suitable type of OHMD, or any other similar device capable of providing an augmented reality view to a user of the device. In particular embodiments, the OHMD 104 may be any wearable device having a head-up display configured to provide an augmented reality view to the user when the user wears the device.

In particular embodiments, navigation information, including images or other information for assisting with navigation, is presented to the user through the OHMD 104. The OHMD 104 is configured to display images and other information, for example, by reflecting projected images and other information onto a display glass or screen positioned in the user's view. In other embodiments, the OHMD 104 may display images or other information through LED, LCD or other suitable display devices associated with the OHMD 104. Accordingly, the OHMD 104 includes a display glass or screen and suitable hardware and software for providing images or other information on the glass or screen.

In particular embodiments, the OHMD 104 includes suitable hardware and software for providing communication connections with the mobile device 102 or the network 101 (or both). In particular embodiments, the OHMD 104 may include one or more optical devices, such as a camera or other image or light capturing device that is configured to capture images or light information from the immediate environment of the OHMD 104. In further embodiments, the OHMD 104 includes one or more further sensors, detectors, receivers or the like, for detecting, sensing or receiving signals from sources within a predefined vicinity of the OHMD 104, such as, but not limited to RFID sensors, RF receivers. In yet further embodiments, the OHMD 104 may include one or more further receivers for receiving satellite position signals, such as, but not limited to global positioning system (GPS) receivers, or gyroscopes or accelerometers. The OHMD 104 may include suitable processing electronics (one or more electronic processors) and electronic memory configured to provide certain processing operations and control other electronics on the OHMD 104 to operate as described herein.

The mobile device 102 may be any suitable mobile communication device, such as, but not limited to a mobile smartphone (such as, but not limited to an iPhone™, an Android™, or the like), smart pad, portable laptop computer, or other network-connected device with suitable processing capabilities. The mobile device 102 may include suitable processing electronics (one or more electronic processors) and electronic memory configured to provide certain processing operations and control other electronics on the mobile device 102 to operate as described herein. The mobile device 102 may include one or more keypads, touchscreens, cameras, microphones, environmental parameter or condition sensors and/or other input devices, gyroscopes or accelerometers.

In further embodiments, the mobile device 102 includes one or more further sensors, detectors, receivers or the like, for detecting, sensing or receiving signals from sources within a predefined vicinity of the mobile device, such as, but not limited to RFID sensors, Bluetooth or RF receivers, or the like. The mobile device 102 may include one or more display devices such as, but not limited to electronic display screens, lamps or other light emitting devices, speakers or other audio output devices. In particular embodiments, the mobile device 102 includes telephone and other network communication electronics and software, processing electronics, electronic storage devices and one or more antennae and receiving electronics for receiving various signals. In yet further embodiments, the mobile device 102 may include one or more further receivers for receiving satellite position signals, such as, but not limited to a global positioning system (GPS) receiver.

The network 101 may include a wide area communication network, such as, but not limited to, the Internet, or one or more Intranets, local area networks (LANs), ethernet networks, metropolitan area networks (MANs), a wide area network (WAN), combinations thereof, or the like. The network 101 may also include one or more of networks provided by various radio access technologies such as, but not limited to, Global Standard for Mobile (GSM), Code Division Multiple Access (CDMA), CDMA2000, Time Division Code Division Multiple Access (TDCDMA), Time Division Synchronous Code Division Multiple Access (TDSCDMA), Wideband Code Division Multiple Access (WCDMA), Time Division Multiple Access (TDMA), Frequency Division Multiple Access (FDMA), Long-Term Evolution (LTE), Voice over LTE (VoLTE), Simultaneous GSM and LTE (SGLTE), Simultaneous Voice and LTE (SVLTE), and/or the like. The network 101 may also include any number of computing devices (e.g., computer, servers, routers, network switches, etc.) that are configured to receive and/or transmit data within the network 101. The network 106 may further include any number of hardwired and/or wireless connections. In particular embodiments, the network 101 may include or represent one or more secure networks configured with suitable security features, such as, but not limited to firewalls, encryption, or other software or hardware configurations that inhibits access to network communications by unauthorized personnel or entities.

The system 100 further includes a server 106 connected for communication on the network 101 and configured to generate and provide navigation information. The server 106 may include processing electronics including at least one processor and suitable hardware and software for connecting and communicating over the network 101. The server 106 may include or be operably connected to a memory 108 or data store that stores software programs or routines and data that the processor(s) of the server employ to help generate the navigation information. The memory 108 may be local or remote to the server 106 (e.g., memory may be local to the server 106 or may be remotely connected to the server 106, for example, over the network 101). In some embodiments, the server 106 may include a desktop computer, mainframe computer, laptop computer, pad device, smart phone device or the like, configured with hardware and software to perform operations described herein.

The system 100 further includes or operates with one or more (e.g., a plurality of) devices 110 that may be located in a building environment. The devices 110 may include, for example, printers or copiers, or other electronic devices, objects or locations, as described above. In certain embodiments, one or more of the devices 110 may be connected to communicate with the server 106, via a wired or wireless connection, for example, over the communication network 101. In such embodiments, the one or more devices 110 includes suitable hardware and software for connecting and communicating over the network 101, and to operate as described herein. In particular embodiments, each device 110 may include at least one processor and electronic memory or data stores that store software programs or routines and data that the processor(s) of the device 110 employ to operate as described. While particular embodiments are described herein with respect to printer devices as the devices 110, other embodiments employ other types of devices other objects or structures in a building environment, for the device 110, including, but not limited to copier devices or other office machines, other types of electronic devices or machines, furniture items, access doors, fire extinguishers or other emergency equipment, medical supplies or equipment, or the like. In further embodiments, instead of devices 110, the system 100 operates to locate structures or areas of a building environment, such as, but not limited to rooms, lobbies, particular walls, windows, doorways, hallways, or other defined areas in the building environment.

The processor(s) included in the OHMD 104, mobile device 102, server 106 and other device(s) 110 may include any suitable data processing device or devices, such as a general-purpose processor (e.g., a microprocessor), or other conventional processor, controller, microcontroller, or state machine. Each processor may also be implemented as a combination of computing devices, e.g., a combination of a DSP and a microprocessor, a plurality of microprocessors, at least one microprocessors in conjunction with a DSP core, or any other such configuration. An electronic memory or data store may be operatively coupled to the processor and may include any suitable device for storing software and data for controlling and use by the processor to perform operations and functions described herein, including, but not limited to, random access memory RAM, read only memory ROM, floppy disks, hard disks, dongles or other RSB connected memory devices, or the like.

In one embodiment, OHMD 104 is a standalone device capable of wireless communication with server 106, for example, through the network 101. In such embodiments, the OHMD 104 may be configured to connect, directly, for communication on the network 101. In another embodiment, OHMD 104 is paired with the mobile device 102, for communication with the server 106. In such embodiments, the OHMD 104 communicates with the server 106 over the network 101, through the mobile device 102. Thus, in particular embodiments, the OHMD 104 communicates with the local mobile device 102 (for example, through a Bluetooth or other local wireless communication link), while the mobile device 102 is connected for communication with the server 106, over the network 101 (for example, through a suitable Internet or other network connection). Various certain operations described herein may be implemented by either one or both of the OHMD 104 and the mobile device 102. Accordingly, certain operations described as being carried out by the mobile device 102 may, instead, be carried out by the OHMD 104, and vice versa.

Server 106 is configured to provide navigation information to the mobile device 102 or OHMD 104 (or both). For example, the navigation information may include any suitable information that provides directions for navigating through a building environment. Such navigation information may include, but is not limited to descriptive text, arrows or other icons that describe or show directions to walk, directions to turn, paths to follow, doors to open, containers to open, elevators, escalators or stairs to use, or the like. In particular embodiments, the navigation information provides turn-by-turn navigation directions. To provide navigation information, the server 106 determines the current location of the user. In particular embodiments, the server 106 receives information that the processor in the server 106 can use to determine the current location of the user. In the context of the present description, a building environment refers to the interior of a single building structure or if multiple building structures, such as, but not limited to, one or more houses, office buildings, malls, airports, depots or stations, auditoriums, stadiums, or other structures having an interior within which a person can walk or travel, as well as campuses, neighborhoods, or other groups of such building structures.

In particular embodiments, the mobile device 102 or the OHMD 104 may determine and transmit data representing the user's location to the server 106, through the network 101. The mobile device 102 or the OHMD 104 may determine data representing the user's location, for example, by reading one or more tags, signs or other location identifiers within the building environment. Accordingly, in such embodiments, the system may further include or operate with a plurality of tags, signs or other location identifiers that are arranged at a corresponding plurality of predefined locations within the building environment. Such tags, signs or other location identifiers may include barcodes, QR codes, other optically readable codes, RFID tags, magnetically readable tags or other electronically readable tags, or the like. The mobile device 102 or the OHMD 104 (or both) may be configured to scan or otherwise read the tags via laser or other optical detection, WiFi, frequency modulation (FM), Bluetooth (BT), near field communication (NFC), or via any other suitable communication link with the tags. The OHMD 104 may be configured to read one or more tags at a given location in the building environment, when the user is present at or near that location and the OHMD 104 is oriented in a direction that allows an optical reader or other sensor to read the tag(s). Accordingly, in particular embodiments, one or more tags are arranged at locations in the building environment where a user is likely to orient the optical reader or other sensor of the OHMD 104, for example, as a user passes through a doorway or travels along a hallway.

The OHMD 104 may be configured to communicate information read from the tags to processing electronics (for example, processing electronics in the mobile device 102 carried by the user, in the remote server 106, or in the OHMD 104, itself). The processing electronics may be configured to determine the location of the user based on the information read from the tags.

For example, each tag may include a readable code or other information that identifies or is associated (in a table or other data association) with a predefined location in the building environment. In such embodiments, the processing electronics is configured to compare the information read from a tag or multiple tags with one or more locations in the table (or other data association) to identify an associated location (as the user's location).

In other embodiments, the processing electronics are configured to determine data representing the user's location in other suitable manners. Further, the processing electronics may use other information from a gyroscope or an accelerometer (or both) on the OHMD 104 or the mobile device 102 (or both), to determine the user's view direction, orientation or motion (or any combination thereof).

According to certain embodiments, a user may enter a request for navigation information, for example, through a user input device on the OHMD 104 or the mobile device 102. The user's navigation request may be, for example, a request to be directed to a particular device, object, room, or other area in the building environment. In one embodiment, the request relates to finding a nearest printer, copier, or other device. In another embodiment, the request relates to finding an available printer, copier or other device, or one that the user of the OHMD 104 is authorized to use. In further embodiments, the request relates to finding the closest available or authorized printer, copier or other device. The request may be communicated, through the network 101, to the server 106.

According to certain embodiments, a user may be provided navigation information automatically. For example, a user in a building may send a request to a device in the building (e.g., the user may send a print job to a printer device in the building). Upon sending the request to the device, the server 106 may receive an indication of the request, and automatically generate navigation information to transmit to the OHMD 104 of the user (e.g., upon receiving an indication of a print job, the server 106 automatically generates navigation information to direct the user to the printer). The user may then use the navigation information to find the device in the building. In another embodiment, the server 106 may receive the indication of the request, and prompt the user with an inquiry, asking the user if assistance is needed in locating the device. Then, the server 106 may provide navigation information to the OHMD 104 of the user upon receiving confirmation from the user that the user would like to receive the navigation information.

The server 106 is configured to receive the request and to determine a destination location for the user. The destination location may be, for example, the location in the building environment of one or more devices, objects, rooms, or other areas to which the request relates. In particular embodiments in which the request relates to an available, authorized or nearest printer, copier or other device, the destination location includes one or more locations of one or more available, authorized or nearest printers, copiers, or other devices.

In particular embodiments, the destination location is determined by reference to pre-stored location data identifying or corresponding to locations of devices, objects, rooms or other areas to which a request may relate. For example, in certain embodiments, data representing predefined locations of one or more printers, copiers or other electronic devices are stored in the electronic memory 108 associated with the server 106. In such embodiments, the server 106 may be configured to retrieve from the memory 108 pre-stored location data associated with a device, object, room or other area to which the request is related.

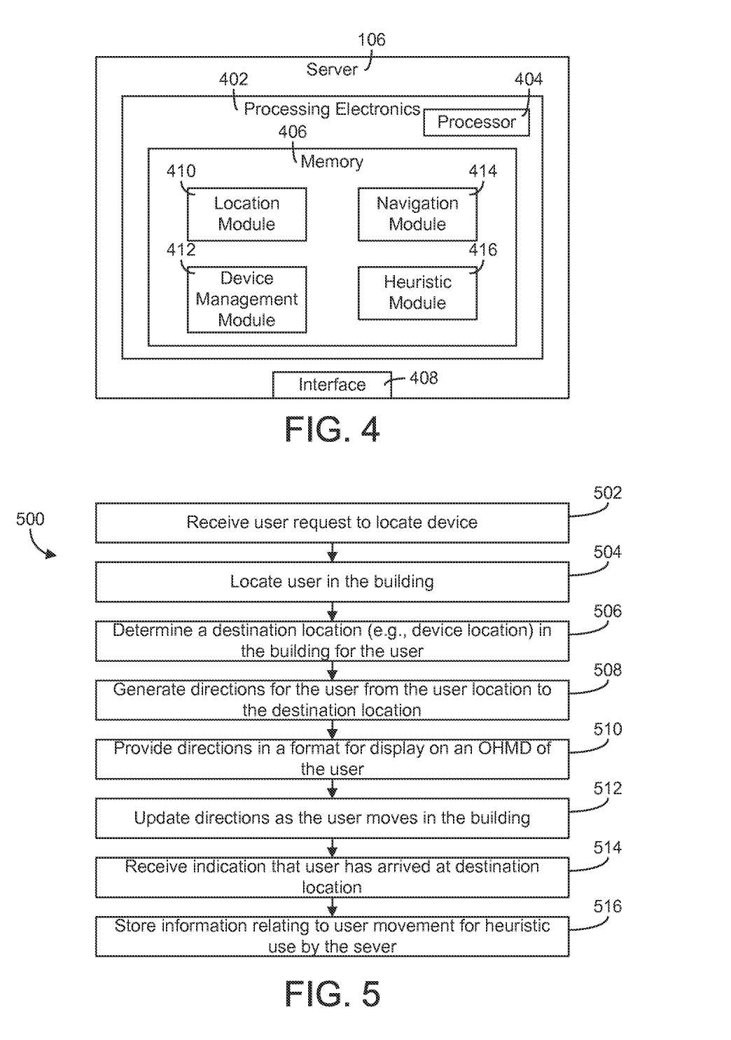

In other embodiments, server 106 may be configured to communicate with the plurality of devices 110 over the network 101. For example, server 106 may query devices 110 to determine which of the devices are available, and then determines the nearest available device to the user. In particular embodiments, the server 106 is further configured to generate navigation directions (such as, but not limited to turn-by-turn directions), to direct the user from the user's current location to the destination location. An example of an operation of a server 106 in determining a destination location and providing turn-by-turn directions is described in greater detail with reference to FIG. 4.

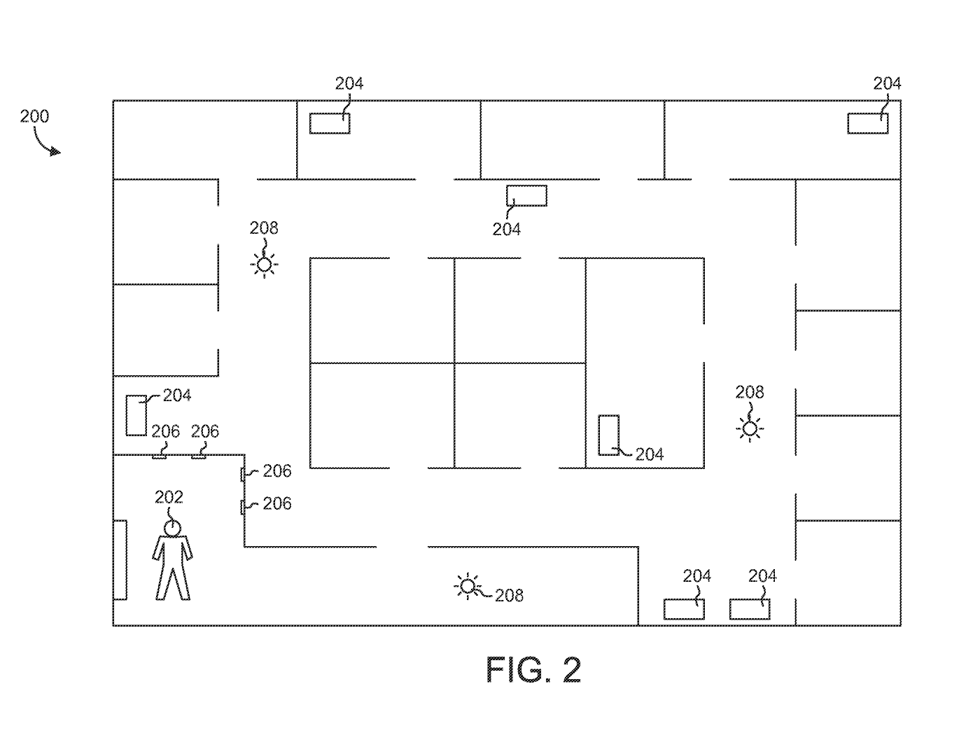

FIG. 2 represents a floor plan of an example of a building environment 200 in which an embodiment of an indoor navigation system is implemented. A user 202 is shown in a first location, and a plurality of devices 204a-204h to which the user may be directed are located at various second locations throughout the building environment 200. The user 202 carries an OHMD 104 and a mobile device 102, such as described above. The building environment 200 of FIG. 2 is provided by way of example to assist in the description. Further embodiments of systems and methods described herein may be implemented in other suitable building environments.

The OHMD 104 or the mobile device 102 (or both) may be configured, as described above, to determine the location of the user within the building environment 200. In one embodiment, the OHMD 104 or the mobile device 102 is configured to read one or more tags 206a-206g in the building environment, as described above. The tags may be placed on walls, ceilings, or floors of the building environment, on any movable or immovable object or structure in the building environment, or the like. In one embodiment, four tags may be placed on each of four walls (or four corners) of a room in the building. In other implementations, tags are placed at locations in the building environment that are likely to be in view, as the user travels through the building environment. For example, one or more tags may be arranged on a wall opposite to, but in alignment with a doorway, such that a user may easily (or likely) orient the OHMD 104 in a direction to read the tag, as the user passes through the doorway. Similarly, one or more tags may be arranged on a wall or other structure located at one or both ends of a hallway, such that a user may easily (or likely) orient the OHMD 104 in a direction to read the tag, as the user travels along the hallway.

The tags 206a-g are placed at pre-defined locations in the building environment. In FIG. 2, a plurality of tags 206a are illustrated near the user 202. Each tag 206a-g may contain data that can be read by the OHMD 104 or the mobile device 102 (or both). In further embodiments, one or more of the tags 206a-g are configured to receive and store further data transmitted to the tags, for example, from the OHMD 104, the mobile device 102 or other device (e.g., a service or programming device). The data may identify, represent or be associated with the location of the tag. The data may identify, represent or be associated with the room, hall or other location in the building environment at which the tag is located. For example, tags 206a may include data that identifies, represents or is associated with an entry lobby or other room in which the tags 206a are located, while tags 206b may include data that identifies, represents or is associated with the hallway in which the device 204b is located. Similarly, the different respective tags 206c, 206e and 206f may include data that identifies, represents or is associated with the different respective rooms in which the devices 204c, 204e and 204f are located. Also similarly, the different respective tags 206d and 206g may include data that identifies, represents or is associated with the different respective hallways in which the devices 204d and 204g are located.

While not shown in FIG. 2, additional tags may be placed in a sufficient number of rooms, hallways or other locations within the building environment, such that one or more tags are likely in view of a user 202, at most (or all) areas in which the user 202 may travel within the building environment. Data stored or otherwise contained in the tags 206a-g may include, but is not limited to codes that represent or are associated with a room number, floor of the building, facing direction of a wall or other structure, building number or name, or the like. By reading one or more tags 206a-g, the OHMD 104 or the mobile device 102 (or both) of the user 202 is able to read information that identifies, represents or is associated with the current location of the user 202 within the building environment. The location is used by the server 106 to generate turn-by-turn directions for the user.

In one embodiment, multiple tags may be used to triangulate the position of the user. For example, multiple tags may be in view of the OHMD 104 or the mobile device 102 of the user 202. The OHMD 104 or the mobile device 102 (or both) may read the tags and provide data read from the tags to the server 106. In such embodiments, the server 106 may be configured to triangulate the position of the user based on data read from multiple tags. It should be understood that the type of tag used in the building may vary based on various embodiments and is not limiting in nature. The tags may be used as identification tags (e.g., tags simply identifying the location of the tag in the building) and checkpoint tags (e.g., tags identifying a particular landmark, device, or other object in the building), and may further have functionality in the building environment, independent of the indoor navigation system.

Referring still to FIG. 2, a plurality of WiFi nodes 208 (e.g., WiFi “hot spots”) are illustrated. The building may include a plurality of WiFi nodes 208 which may be in wireless communication with the mobile device 102 or the OHMD 104 of the user, when the mobile device 102 or OHMD 104 is within sufficient proximity and range of the WiFi node 208. In one embodiment, WiFi nodes 208 may be used to determine the location of the user. For example, signal strength between the a WiFi node 208 and a mobile device of the user may be used to determine how far a user is from the WiFi node 208. In another embodiment, the mobile device 102 or the OHMD 104 of the user may identify one WiFi node 208 from another and, in that manner, determine the location of the mobile device 102 or OHMD 104 relative to that WiFi node. In such embodiments, the mobile device may retrieve information about WiFi node 208. For example, the mobile device may retrieve a name or other identifier of the node, which may indicate the location of the node (e.g., a WiFi node named “2^{nd} floor”). As another example, the MAC address of the WiFi node may be retrieved by the mobile device and provided to the server 106 for identification. In such embodiments, an table or other data association may be stored in the memory 108, for associating each different respective WiFi node code or MAC address with a different respective location in the building environment (e.g., the pre-defined location of the WiFi node).

In one embodiment, other visible cues may be used to identify the location of the user. For example, the OHMD 104 or the mobile device 102 (or both) may capture images of an area, and provide the images to the server 106. The server 106 may identify the location of the user based on the images. For example, the server 106 may compare captured images with pre-stored images or representations of predefined locations within the building environment to identify a match, or to identify a landmark in the captured image.

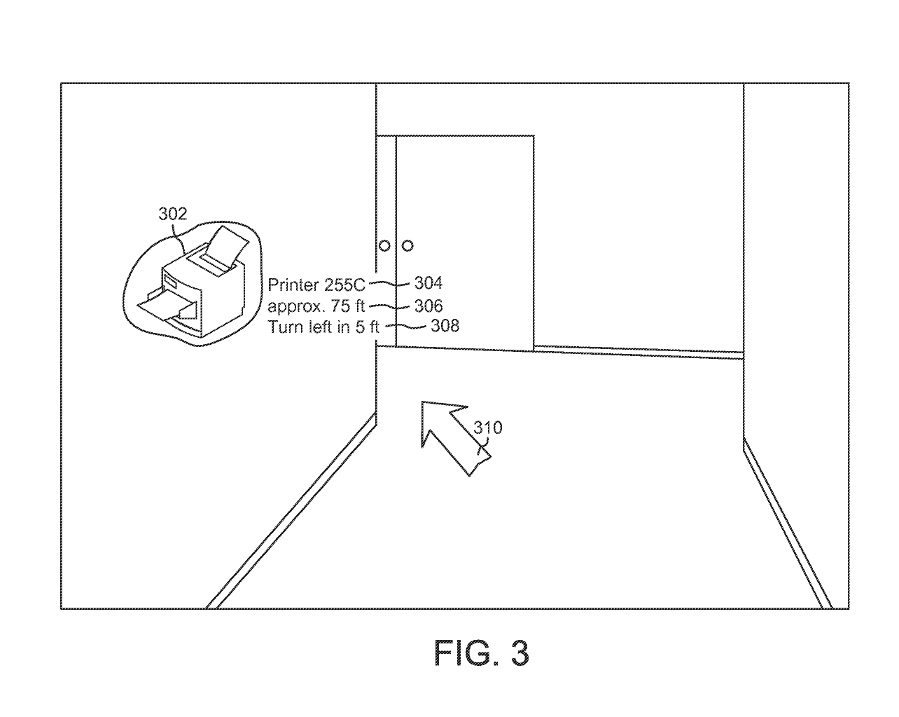

The drawing in FIG. 3 represents an example of a user's view of a head-up display, with the glass or screen of the OHMD 104 supplementing a real world view of the building environment (from the direction of view of the user). In the embodiment of FIG. 3, the user has submitted a request for the location of a nearby printer device as the destination location. Based on the user's current location as determined by the server 106 and the destination location as determined by the server 106, the server 106 may provide image information to be displayed on the user's OHMD 104.

In one embodiment, the image information includes an icon 302 representative of a destination location or object. In the example of FIG. 3, image information provided to the OHMD 104 includes information for displaying an icon 302 (shown as a printer device) at a predetermined location on the glass or screen of the OHMD 104, where the predetermined location corresponds to the actual location of the requested object (the printer device) relative to the user's position, orientation and direction (or field of view). For example, the printer may be located in a room, behind one or more walls that are located between the current user's location and the destination location (or printer device location). The icon 302 may be displayed such that the icon 302 appears to the user (via the augmented display) in a position corresponding to the actual destination location, as if the user is viewing the object (e.g., the printer device) through the one or more walls. Accordingly, the head-up display of the OHMD 104 can provide the user with a better understanding of the location of the requested object (the destination location) relative to the user's current location, even if walls, doors or other objects or structures are located between the user and the destination location.

In other embodiments, the OHMD 104 may be configured to display the icon 302 in other ways. For example, in further embodiments, the image information provided for display on the OHMD 104 may show the walls in a partially or wholly transparent manner, or may add color, highlight, intensity or other image attributes to accentuate the icon 302. The image information may also include text that provides a description or a name 304, or identifies other features or characteristics of the requested object or destination location, including, but not limited to, information identifying the on/off status of the requested object, the availability status of the requested object, the operable functions of the requested object, the state of consumable materials (such as paper, toner, ink, or other consumables) of the requested object, or the like.

The image information may further include text or other images representing a distance or approximated distance 306 to the requested printer device or other requested object (e.g., a distance between the user's current location and the destination location). The image information to be displayed on the OHMD 104 may further include turn-by-turn directions 308, identifying a direction for the user to turn (or a direction to turn and a distance to travel before or after turning), to travel from the user's current location to the destination location. For example, in FIG. 3, directions 308 describe the next turn that the user may take to move toward the destination location. The image information may further include other direction or informational icons that can be displayed on the OHMD 104, such as, but not limited to arrows 310 indicating a path to the requested object, warnings, messages or alerts (e.g., indicating that an area in the building environment is high traffic, indicating that there are obstacles in the building environment, indicating that the requested printer or other object is currently busy with another job, or indicating other information regarding the building environment or the requested object), or the like.

Referring now to FIG. 4, example operations of the server 106 are described in greater detail. The server 106 may have processing electronics 402, including at least one processor 404 and memory 406 configured to control operations of the server 106 as described herein. (The memory 406 may correspond to or be part of the memory 108 described above with respect to FIG. 1.) The processor 404 may include a general purpose processor, an application specific integrated circuit (ASIC), one or more field programmable gate arrays (FPGAs), a group of processing components, or other suitable electronic processing components. The memory 406 may include one or more electronic memory devices (such as, but not limited to, RAM, ROM, flash memory, hard disk storage, or the like) for storing data and/or computer code for facilitating and carrying out various operations described herein. The memory 406 may be or include volatile memory or non-volatile memory. The memory 406 may include database components, object code components, script components, or any other type of information structure for supporting the various operations and information associations and structures of the present disclosure.

In one embodiment, the server 106 is a centralized server configured to carry out server operations of the indoor navigation system. In another embodiment, the server 106 is a decentralized server composed of a plurality of servers at various locations, to which server operations for the indoor navigation system may be distributed. Accordingly, it should be understood that the modules as shown in FIG. 4 may be executed in a single, central server or across a plurality of servers.

In the embodiment of FIG. 4, the memory 406 includes a plurality of modules for carrying out operations as described herein. Each module may be one or more software programs and data structures for configuring the processor 404 to carry out operations as described herein. For example, the memory 406 includes a location module 410 configured to determine the current location and orientation of a user in the building environment. In further embodiments, the location module for determining the location of the user may be in memory associated with the user's mobile device 102 or the user's OHMD 104 (or both), such that the user's current location would be determined remotely from the server 106 (for example, by the processing electronics of the mobile device 102 or the OHMD 104). Alternatively, or in addition, the user's mobile device 102 or the user's OHMD 104 (or both) may obtain location information through other sources, such as, but not limited to a WiFi hotspot device, GPS signals or the like, to provide, supplement or verify a user's current location.

In one example embodiment, the location module 410 receives information from the mobile device 102 or the OHMD 104 of the user, and employs that information to determine the location of the user. For example, the mobile device 102 or the OHMD 104 (or both) may read one or more tags in the building environment. The mobile device 102 or the OHMD 104 (or both) may then transmit data read from the tags (or data corresponding to data read from the tags) to the location module 410. The data may include a tag identifier (such as, but not limited to, a name, code or other data on the tag that identifies the location of the tag to location module 410). In one embodiment, the data includes a code that is associated with a location within the building environment in a table (or other data association) stored in the memory 406 (or in memory in the mobile device 102 or the OHMD 104).

In one embodiment, location module 410 determines the position of the user by triangulation, based on information read from multiple tags in the building environment. For example, if tag information for four tags is received by location module 410, a location determination is made based on locations in the building environment at which it is possible for a mobile device to capture data from each of those four tags. In such embodiments, a table (or other data association) as described above is configured to associate tag information of a plurality of sets of multiple tags with locations in the building environment corresponding to places where the multiple tags in one of the sets could be read.

As another example, the location module 410 may receive, over the network 101, a communication from a WiFi node device in the building environment, indicating the presence of a mobile device (and therefore the user) within the WiFi hot spot (within the reception range of the WiFi node device). In such embodiments, a WiFi node device may be connected for communication on the network 101 and communicate information to the server 106, regarding which user devices 102 or the OHMDs 104 (or both) are within the WiFi hot spot. In such embodiments, the server may identify the location within the building environment of the WiFi hot spot (and, thus, of the user device 102 or the OHMD 104 within the WiFi hot spot), for example, with reference to pre-stored locations associated with known WiFi node devices and WiFi hot spot areas within the building environment. In another embodiment, location module 410 may receive information corresponding to a signal strength of a WiFi node from the mobile device 102 or the OHMD 104 (or both), and may employ the signal strength information to determine the location of the mobile device 102 or the OHMD 104 (and, thus, the current location of the user). In such embodiments, the identity of the WiFi node can be obtained from the MAC address or other identifier associated with the WiFi node device, and the actual location of each WiFi node within the building environment may be pre-defined and stored in memory associated with the mobile device 102, the OHMD 104 or the server 106.

The location module 410 may further determine an orientation of the user (e.g., a direction in which the user is currently facing). In one embodiment, tag information may be used (e.g., by determining that the user is facing a certain direction when a particular tag is in view of the OHMD). In such embodiments, the current location of the user and the known location of the tag may be used to determine the direction that the user is facing as a direction from the user's current location toward the known tag location. In one embodiment, a gyroscope of the OHMD 104 or the mobile device 102 may be used to determine the orientation of the user. In such embodiments, the gyroscope may provide signals representing the user's movement from a previously detected current location and orientation of the user, to determine a new or updated direction in which the user is facing. In particular embodiments, the location module 410 may be configured to determine or update a user's orientation, direction or current location (or any combination thereof) based on navigation directs (such as, but not limited to turn-by-turn directions) provided to the user.

In one embodiment, the OHMD 104 or the mobile device 102 (or both) may include an accelerometer, configured to determine the user's movements. The location module 410 may use accelerometer data in conjunction with information read from one or more tags to determine a current position of a user. In further embodiments, the location module 410 may be configured to employ information from one or more (or any combination of) tags, WiFi nodes, a gyroscope, and an accelerometer, to determine the location of the user.

The location module 410 may be configured to track the current location of the user as the user follows the navigation directions provided by the server 106. For example, location module 410 may use the accelerometer and gyroscope information to determine in what direction the user is heading. The location module 410 may provide the location information to the other modules of the server 106 in real-time.

In the embodiment of FIG. 4, the memory 406 also includes a device management module 412. The device management module 412 is configured to receive a request from a user to find a requested device or other object (e.g., a printer or copier), and to select a device or object to direct the user towards. In one embodiment, the request is input by the user via a user input device on the mobile device 102 or the OHMD 104. For example, the user may ask for the nearest printer, in response to which, the device management module 412 determines one or more of the nearest printers based on location information from the location module 410. As another example, the user may request a particular type of printer, a specific printer, a printer that the user is authorized to use, or a printer that meets other specified criteria. In response, the device management module 412 may identify one or more printers that meet that criteria.

In one embodiment, the device management module 412 may request input from devices connected to the server 106 via the network 101. For example, upon receiving a user request, the device management module 412 may send an inquiry message to all available printer devices (or certain predefined printer devices) in the network or in the building environment. The printer devices are configured to respond to the inquiry message, with a response message to the server 106, where the response message may include, but is not limited to, information identifying the responding printer device, information relating to the status of the responding printer device, information relating to the location within the building environment of the responding printer device, or other information. The device management module 412 may receive one or more response messages from one or more printers and, based at least in part on the response messages, may select an available printer device (for example, a printer device that is nearest or most accessible to the user, or a printer device that is both near and available, or another suitable printer device).

In one embodiment, a list (or other data structure) of available printer devices may be stored in the server 106 or the memory 108. The device management module 412 may access the list (or other data structure) and select the nearest or most accessible (or other suitable) printer device, in response to the user's request. In another embodiment, the device management module 412 may use a combination of the list (or other data structure) and response messages from available printers to select a printer.

In various embodiments, the device management module 412 may account for access rights or authorization rules. For example, some printer devices may be inaccessible to a particular user because the printer devices are located in secured rooms, or because the user is not authorized to use such printer devices, etc.). In such embodiments, the device management module 412 may be configured to exclude such printer devices from those that may be selected in the response to the user's request. In further embodiments, the device management module 412 may account for the status of various printer devices. For example, printer devices that are currently occupied with other jobs or that are otherwise busy or out of service may be excluded from those that may be selected in response to the user's request. In yet further embodiments, the device management module 412 may receive status information from one or more printer devices relating to a time at which the one or more printer devices is expected to be available in the future. In such embodiments, the device management module 412 may include such printer devices in a response to the user's request, based at least in part on the time of availability of the printer devices (for example, by selecting a next available printer device).

The device management module 412 may determine that a plurality of printer devices are available to a user in the building environment. In particular embodiments, instead of selecting one of the printer devices, the device management module 412 selects a plurality of the printer devices and displays a list (or other data structure) of devices to the user. In such embodiments, the user may select a printer device from the list (or other data structure) and receive navigation directions to that printer device. In such embodiments, the user may select a printer device, by inputting selection information through a user input device associated with the OHMD 104 or the mobile device 102.

The device management module 412 is described above with respect to locating a printer device. However, it should be understood that the, in further embodiments, the module 412 may be configured for locating other objects, structures or areas of a building environment, including, but not limited to locating copier devices or other office machines, other types of electronic devices or machines, furniture items, access doors, fire extinguishers or other emergency equipment, medical supplies or equipment, rooms or other defined areas in the building environment, or the like. For example, the device management module 412 may be configured to locate a particular route, such as an evacuation route that a user may follow to exit a building during an emergency. As another example, the device management module 412 may be configured to locate other personnel in the building area, and to provide navigation assistance to a user for finding the personnel in the building.

In the embodiment of FIG. 4, the memory 406 also includes a navigation module 414 configured to generate directions from a current user location to a destination location (e.g., the location of a requested device). The navigation module 414 may be configured to receive the current user location from the module 410 and the destination location from the module 412, and determine navigation directions (such as, but not limited to turn-by-turn directions) to guide the user to the destination location from the current user location. In one embodiment, the navigation module 414 may access data corresponding to a floor-plan or layout of a building environment (or portions thereof) from memory 108 or another suitable source. The navigation module 414 may also access status information regarding the floor-plan or layout (e.g., information that indicates whether or not a particular path is blocked, whether or not a particular area is crowded with traffic, whether or not a particular path is commonly used by others) in order to determine the directions. In such embodiments, the navigation module 414 may use such floor-plan or layout and status information to determine a suitable path and navigation directions to provide to the user.

The navigation module 414 is further configured to generate one or more images (which may include overlays) to display on the OHMD 104 of the user. For example, the navigation module 414 may retrieve from memory 406 image data corresponding to an image of the requested object at the destination location (e.g., a printer device) and generate an image (e.g., an icon) to be displayed on the OHMD 104 of the user (for example, as shown in FIG. 3). The navigation module 414 may use the current position and orientation of the user (determined by module 410) to determine the proper position on head-up display of the OHMD 104, to display the icon. Further, the navigation module 414 may adjust the display of the icon (e.g., resizing the icon based on distance to the printer device or destination location), as the user moves towards or relative to the printer device (and the destination location). The navigation module 414 may highlight or otherwise enhance the icon, based on current status of the printer device.

In one embodiment, the navigation module 414 is configured to determine a distance between the user and the requested device (or destination location), and to provide text to display on the OHMD 104 indicating the distance. In one embodiment, the navigation module 414 determines navigation directions in the form of turn-by-turn directions for the user. The turn-by-turn directions indicate to the user, for example, which way to turn, which hall to walk down, which floor to go to, which door to open, which room to enter, etc. The turn-by-turn directions may be displayed in various forms. For example, the directions may be displayed as descriptive text messages on the OHMD 104, as one or more arrows that point in a direction for the user to follow, as an icon that is overlayed over an object, structure or area in the building environment, or a combination thereof.

In further embodiments, the navigation module 414 is configured to further assist the user while the user is traversing through the building environment. For example, the navigation module 414 may adjust or change a destination location, for example, if the status of a requested device at the destination location changes in a manner that renders the device unavailable. As yet another example, as the user is traversing through the building environment, the OHMD 104 or the mobile device 102 may read location information (e.g., from a tag, from a WiFi node, etc.) that location module 410 uses to update the user location. The navigation module 414 may use the updated information to determine if the user is correctly following the navigation directions provided to the OHMD 104, or if the user has selected an alternate path. In such embodiments, the navigation module 414 may be configured to adjust the navigation directions in real-time, based on the updated information of the user location.

In particular embodiments, the navigation module 414 is configured to provide navigation directions in the form of text descriptions (such as, but not limited to text descriptions of turn-by-turn directions) when the user's location is a predefined distance from the requested object (or destination location). Then, as the user nears the requested object (or destination location), the text descriptions are supplemented with or replaced by an image icon that shows the requested object (for example, in the form of an icon 302 as described with respect to FIG. 3). In this manner, the navigation module 414 may be configured to provide a first type of navigation directions (such as, but not limited to textual descriptions) when the user is more than a predefined distance from the requested object (or destination location), and to provide a second type of navigation directions (such as, but not limited to display of image icons that represent the requested object, as if viewed through walls, doors or other structures), when the user is less than the predefined distance from the requested object (or destination location).

As the user nears the requested object (or destination location), the positions of the icon displayed on the OHMD 104 may become less accurate relative to the actual location of the requested object. For example, when the user is within a few feet of the printer device or other requested object, the position of the printer device or object icon on the head-up display of the OHMD 104 may be offset from the actual, real world location of the printer device as viewed by the user. Accordingly, in further embodiments, when the OHMD 104 is within a second predefined distance of the printer device, the navigation module 414 may provide more detailed textual directions, arrows or other direction indicators, or may omit the use of the object icon.

In the embodiment of FIG. 4, the memory 406 also includes a heuristic module 416. The heuristic module 416 may record or “learn” by tracking the user's path in the building as the user moves towards his or her destination location (e.g., towards the printer). For example, heuristic module 416 may use location information from module 410 to determine if the user correctly followed particular navigation directions provided by the module 414. Further, heuristic module 416 may determine if the user deviated from the navigation directions, and if the user still found the requested object (such as a requested printer device).

By tracking users movements, the heuristic module 416 may determine patterns of user movements. The determined patterns, and other information, is used by the heuristic module 416 to modify future directions and other suggestions given by the server 106. The learned information is used in a feedback loop to allow the server 106 to learn (e.g., by machine learning) a better set of directions for the user. For example, the heuristic module may be configured to determine if a plurality of users deviate from certain navigation directions in a similar manner. Such deviations may suggest that an alternative route to the requested object may be preferred. In such embodiments, the heuristic module 416 may provide such information to the navigation module 414, such that the navigation module 414 may adjust navigation directions based on the deviation determinations of the heuristic module. As another example, heuristic module 416 may track an amount of time, amount of detours taken or other factors relating to the user's ease in following the navigation directions. In such embodiments, the heuristic module 416 or the navigation module 414 may be configured to determine one or more alternate routes to the requested object (destination location), such that the OHMD 104 displays an alternate route. Thus, in particular embodiments, the heuristic module 416 learns the behavior of users of the indoor navigation system over time and determines possible adjustments for future use.

In various embodiments, the server 106 may be configured to provide checkpoint updates. For example, the building environment may include “checkpoint” tags or other such tags that, when read by the OHMD 104 or mobile device 102, can be used by the server 106 to verify that the user is taking a correct path towards a device. As another example, the user may confirm to server 106 that the user has reached the requested object (or destination location) successfully, for example, by entering a confirmation message on a user input device of the OHMD 104 or the mobile device 102. In other embodiments, the confirmation message may be provided in the form of the reading of a tag, a WiFi communication, a GPS location detection or other suitable location detection as carried out by the OHMD 104 or the mobile device 102 at the destination location. In such embodiments, the server 106 may receive the confirmation message, and the heuristic module 416 may use the confirmation message for tracking user behavior.

The server 106 is shown to include a communications interface 408 configured to facilitate communications with the user via mobile device 102 or the OHMD 104, and with various devices 110 in the building environment. The interface 408 may be any suitable wired and/or wireless communication interface.

Referring now to FIG. 5, a flow chart of a process 500 for providing navigation assistance to a user in a building environment is shown, according to an exemplary embodiment. The process 500 may be executed by, for example, the server 106.

The process 500 includes receiving a user request to locate a device (block 502). The device may be, for example, a printer or copier. A user may initialize the process 500 when the user wishes to find a device in a building environment. In one embodiment, the user may request the location of the nearest usable predefined device (such as, but not limited to a printer device). In another embodiment, the user may request the location of a particular device (such as a particular printer device).

The process 500 further includes locating the user in the building (block 504). In one embodiment, the server 106 is configured to receive information from the OHMD 104 or the mobile device 102 of the user, to allow the server 106 to define the current user location. For example, the OHMD 104 or the mobile device 102 of the user may scan and read information from one or more tags in the building, where the information relates to or is associates with predefined locations in the building. The information may be used by the server 106 (or by the OHMD 104 or the mobile device 102 of the user) to determine the location of the user. In another embodiment, one or more WiFi nodes may be used to locate the user (e.g., where the OHMD 104 or the mobile device 102 may retrieve a MAC address or other identifier of the WiFi node and provide the identifier to the server 106, or where the signal strength between the mobile device and the WiFi nodes may be used to triangulate or otherwise determine the position of the OHMD 104 or the mobile device 102, and therefore the user).

In one embodiment, block 504 includes determining an orientation and amount of movement of the user. For example, information from the gyroscope of the OHMD 104 or the mobile device 102 may be used to determine a direction the user is facing. As another example, information from the accelerometer of the OHMD 104 or the mobile device 102 may be used to determine an amount of movement or a direction the user is heading in the building.

The process 500 includes determining a destination location for the user (block 506). In one embodiment, block 506 may include referring to the user request to select a device to direct the user towards. For example, if the user request relates to finding the nearest printer device, the server 106 may be configured to select the location of one or more of the nearest available printer devices as the destination location. Block 506 may include retrieving device information from a remote or local memory, or requesting status information from one or more devices (or both).

The process 500 includes generating directions for the user (block 508) and providing the directions in a format for display on the OHMD 104 of the user (block 510). In one embodiment, blocks 508-510 include generating one or more displays to provide on the OHMD 104 of the user. For example, an icon to represent the requested device at the destination location may be transmitted to the OHMD 104, along with information relating to the location of the requested device. The OHMD 104 is configured to provide an augmented display of the location of the requested device relative to the user, as described above. Blocks 508-510 may further include generating and transmitting other navigation directions or indicators to the OHMD 104 (such as, but not limited to, arrows, text, etc.), examples of which are generally shown in FIG. 3.

In particular embodiments, the process 500 also includes updating the directions as the user moves (block 512). For example, the server 106 may receive updates about the changing location of the user in the building environment (e.g., using accelerometer or gyroscope data, using updated information from the WiFi nodes, receiving information from newly scanned tags, or combinations thereof), as the user moves through the building environment. The server may update the navigation directions given to the user.

In particular embodiments, the process 500 includes receiving a confirmation that the user has reached the destination location (block 514). In one embodiment, the user may provide the confirmation to the server 106. In another embodiment, the server 106 may detect when the user has reached the destination location, to provide confirmation. In further embodiments, the process 500 may include storing user information (block 516), navigation information, updated navigation information and the like, for use by the server to develop future navigation instructions (e.g., in a heuristic manner), as described above.

In one embodiment, the indoor navigation system may further provide audio output to the OHMD 104 or the mobile device 102 (or both). In such embodiments, in addition to the visual directions provided for display on the OHMD 104, the server may provide audible navigation directions to the user. The audible navigation directions may provide audible instructions, for example, to instruct the user to make a turn, to enter a room, to travel a particular distance, or the like. In particular embodiments, the audible navigation directions may also provide audible information regarding the distance that the user is from the destination location.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A system for providing indoor navigation information to an optical head-mounted display (OHMD) of a user, the system comprising a server configured to:
determine a current location of the user in a building environment;
receive a request from the user, the request relating to a query to find a defined destination in the building environment;
determine a destination location within the building environment corresponding to a location of the destination;
generate directions to guide the user to the destination location from the current location; and
generate an augmented display for the OHMD of the user, the augmented display relating to the generated directions, the destination location, or both the generated directions and the destination location.

2. The system of claim 1, wherein the destination location is a location of an electronic device in the building environment.

3. The system of claim 2, wherein the electronic device is a printer or a copier.

4. The system of claim 2, wherein:
the server is further configured to receive status information corresponding to the availability of one or more electronic devices in the building environment; and
the server is configured to determine the destination location within the building environment by determining a location of one of the one or more electronic devices that is available or is closest to the current location of the user, or is both available and closest to the current location of the user.

5. The system of claim 1, wherein determining the current location of the user comprises:
reading, at a mobile device of the user or the OHMD of the user, one or more tags located in the building environment; each tag including information about the location of the tag in the building environment, and
associating information read from the tags with a location to define as the current location of the user.

6. The system of claim 5, wherein the one or more tags comprise at least one RFID tag, barcode, or QR code.

7. The system of claim 5, wherein the server is further configured to determine a direction and speed of movement of the user based on information from a gyroscope and from an accelerometer of the OHMD of the user.

8. The system of claim 1, wherein determining the current location of the user comprises determining a current location from a MAC address of one or more WiFi nodes located in the building environment, or from signal strength between a mobile device of the user and one or more WiFi nodes located in the building environment.

9. The system of claim 1, wherein:
the augmented display includes an icon representing a device or other object at the destination location; and
the icon is displayed on the OHMD of the user at a position corresponding to a position of the device or other object at the destination location, through a wall or other obstacle in the user's view.

10. The system of claim 1, wherein the augmented display includes one or more of:
text describing a path to the destination location;
text or numbers representing a distance to the destination location from the current location; and
arrows or other indicia identifying the path to the destination location.

11. A method for providing indoor navigation information to an optical head-mounted display (OHMD) of a user, the method comprising:
determining, with a processor, a current location of the user in a building environment;
receiving, by the processor, a request from the user, the request relating to a query to find a defined destination in the building environment;
determining, with the processor, a destination location within the building environment corresponding to a location of the destination;
generating, with the processor, directions to guide the user to the destination location from the current location; and
generating an augmented display for the OHMD of the user, the augmented display relating to the generated directions, the destination location, or both the generated directions and the destination location.

12. The method of claim 11, wherein the destination location is a location of an electronic device in the building environment.

13. The method of claim 12, wherein the electronic device is a printer or a copier.

14. The method of claim 12, further comprising:
receiving status information corresponding to the availability of one or more electronic devices in the building environment; and
determining, with the processor, the destination location within the building environment by determining a location of one of the one or more electronic devices that is available or is closest to the current location of the user, or is both available and closest to the current location of the user.

15. The method of claim 11, wherein determining the current location of the user comprises:
reading, at a mobile device of the user or the OHMD of the user, one or more tags located in the building environment; each tag including information about the location of the tag in the building environment, and
associating information read from the tags with a location to define as the current location of the user.

16. The method of claim 15, wherein the one or more tags comprise at least one RFID tag, barcode, or QR code.

17. The method of claim 15, further comprising determining a direction and speed of movement of the user based on information from a gyroscope and from an accelerometer of the OHMD of the user.

18. The method of claim 11, wherein determining the current location of the user comprises determining a current location from a MAC address of one or more WiFi nodes located in the building environment, or from signal strength between a mobile device of the user and one or more WiFi nodes located in the building environment.

19. The method of claim 11, wherein generating the augmented display comprises:
generating an icon representing a device or other object at the destination location; and
displaying the icon on the OHMD of the user at a position corresponding to a position of the device or other object at the destination location, through a wall or other obstacle in the user's view.

20. The method of claim 11, wherein generating the augmented display includes one or more of:
displaying text describing a path to the destination location;
displaying text or numbers representing a distance to the destination location from the current location; and
displaying arrows or other indicia identifying the path to the destination location.
